(19) United States
(12) Patent Application Publication
(10) Pub. No.: US 2015/0012311 A1
(43) Pub. Date: Jan. 8, 2015

(54) SYSTEM AND METHOD FOR PROCESSING PREFERENTIAL ADMISSION OF INDIVIDUALS AND GROUPS TO PHYSICAL VENUES

(71) Applicant: QR Loyalty Systems Inc., Vancouver (CA)

(72) Inventors: Nigel C. Malkin, Vancouver (CA); Jeffrey A. LaPorte, Vancouver (CA)

(21) Appl. No.: 14/493,213

(22) Filed: Sep. 22, 2014

Related U.S. Application Data
(63) Continuation of application No. 13/436,599, filed on Mar. 30, 2012, now abandoned.
(60) Provisional application No. 61/469,596, filed on Mar. 30, 2011.

(51) Int. Cl. G06Q 10/02

(52) U.S. Cl. CPC G06Q 10/02
USPC 705/5

(57) ABSTRACT

A method for facilitating preferred admission transactions between venues and customers, comprises: receiving a request for preferential admission at a server from a customer device, the request identifying the venue to which the request applies; delivering a notification of request for preferential admission to a remote venue device; receiving a response at the server from the remote venue device, the response indicating either acceptance or rejection of the request for preferential admission; delivering notification of acceptance of the preferential admission request to the customer device; and charging the customer for the preferred admission service.

### CROSS REFERENCE TO RELATED APPLICATION

This application is a continuation of U.S. application Ser. No. 13/436,599, filed Mar. 30, 2012, which claims the benefit of U.S. Provisional Application No. 61/469,596, filed Mar. 30, 2011, both of which are incorporated by reference in their entirety.

### FIELD OF THE INVENTION

This invention relates generally to the field of reservation and line-up management systems.

### BACKGROUND OF THE INVENTION

A segment of customers regularly tip host staff and maître d's at restaurants for immediate seating when no reservations are available or when line-ups exist. The same transactions occur between customers and door staff for access to busy nightclubs when line-ups exist.

However, there are market inefficiencies that result in a significant number of potential transactions being unrealized. Many affluent consumers would gladly tip the host staff or maître d' to be seated faster, but don't ask out of fear of possible rejection or embarrassment. Many host staff members and maître d's would gladly accept a tip, but cannot suggest this option is available, nor can they have such a conversation in front of other guests who are waiting for a table. Among those customers and venue staff who do currently participate in such transactions, the transactions are part of an underground, grey market, cash-based economy. The restaurant operators who own the establishments at which there is demand for these transactions rarely receive any portion of the tips, and sales taxes are not collected on these transactions.

As a result, there is a need for a system through which venue owners and operators can accept customer requests for preferential admission, and realize the full economic value of the admission to a venue when customer demand exceeds venue capacity. It would be desirable to have a way to achieve this in a practical and cost efficient manner. It is an object of the present invention to obviate or mitigate the above disadvantages.

### SUMMARY OF THE INVENTION

The present invention provides, in one aspect, a server in an electronic preferential admission system, the server comprising: a non-transitory computer-readable storage medium having executable computer program instructions for facilitating electronic preferential admission transactions between remote customers and remote venues, the computer program instructions comprising: a customer communication module configured to receive a request for preferential admission at the server from a remote customer device, the request identifying the venue for which the preferential admission is requested, the request also identifying the party size for which the preferential admission is requested; a venue communication module configured to deliver a request for preferential admission from the server to a remote venue device, the venue communication module further configured to receive a response from the remote venue device accepting or declining the request; and a processor for executing the computer program instructions.

The present invention provides, in another aspect, a computer product having a non-transitory computer-readable storage medium having executable computer program instructions embodied therein for providing a server a means to facilitate preferred admission transactions between remote customers and remote venues, the computer product comprising: a customer communication module configured to receive a request for preferential admission at the server from a remote customer device, the request identifying the venue for which the preferential admission is requested, the request also identifying the party size for which the preferential admission is requested; and a venue communication module configured to deliver a request for preferential admission from the server to a remote venue device, the venue communication module further configured to receive a response from the remote venue device accepting or declining the request.

The present invention provides, in another aspect, a method for facilitating preferred admission transactions between venues and customers, comprising: receiving a request for preferential admission at a server from a customer device, the request identifying the venue to which the request applies; delivering a notification of request for preferential admission to a remote venue device; receiving a response at the server from the remote venue device, the response indicating either acceptance or rejection of the request for preferential admission; delivering notification of acceptance of the preferential admission request to the customer device; and charging the customer for the preferred admission service.

The present invention provides, in another aspect, a non-transitory computer-readable storage medium having executable computer program instructions for providing a server in a system having remote customers and remote venues, the server for facilitating preferred admission transactions between the remote customers and the remote venues, the computer program instructions comprising: a customer communication module configured to receive a request for preferential admission at the server from a remote customer device, the request identifying the venue for which the preferential admission is requested, the request also identifying the party size for which the preferential admission is requested; and a venue communication module configured to deliver a request for preferential admission from the server to a remote venue device, the venue communication module further configured to receive a response from the remote venue device accepting or declining the request.

The present invention provides, in another aspect, a method for a customer to reserve at least one place and concurrently secure preferential admission at a venue which comprises:

a) sending from a customer device a request for both a reservation and a preferential admission to a venue, the request identifying the venue to which the request applies and the number of desired reservations and preferential admissions;

b) delivering a notification of request for both the reservation and preferential admission to a venue device;

c) receiving a response from the venue device, the response indicating either acceptance or rejection of the request for the reservation and indicating either acceptance or rejection of the request for the preferential admission (the “outcomes”);

d) delivering notification of the outcomes to the customer device; and

e) if there is acceptance of the request for the preferential admission charging the customer for such preferential admission.

The present invention provides, in another aspect, an apparatus comprising: a storage device; a processor connected to the storage device; the storage device storing a program for controlling the processor; and the processor operative with the program to: receive a request for preferential admission to a venue, in which the request to secure admission to said venue ahead of other customers who have not paid extra for such admission for a particular time and a particular date; determine an availability of the request for such preferential admission; outputting an indicia that the request for such preferential admission has been accepted or denied.

### BRIEF DESCRIPTION OF THE DRAWINGS

FIG. 1 is a high-level block diagram of a computing environment according to one embodiment of the present invention.

FIG. 2 is a high-level block diagram illustrating a functional view of a typical computer system for use as one of the entities illustrated in the environment of FIG. 1 according to an embodiment of the present invention.

FIG. 3 is a high-level block diagram illustrating modules within a customer according to one embodiment.

FIG. 4 is a high-level block diagram illustrating modules within a venue according to one embodiment.

FIG. 5 is a high-level block diagram illustrating modules within the preferential admission server according to one embodiment.

FIG. 6 is a flow chart illustrating the operation of the preferential admission server according to one embodiment.

The figures depict an embodiment of the present invention for purposes of illustration only. One skilled in the art will readily recognize from the following description that alternative embodiments of the structures and methods illustrated herein may be employed without departing from the principles of the invention described herein.

### DETAILED DESCRIPTION OF THE PREFERRED EMBODIMENTS

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

### I. Terms

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in a sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

The term the venue is to be interpreted broadly and encompasses any venue which provides goods or services and in which a customer would benefit from paying for preferential admission to secure entry or attendance. The venue may be selected from the group consisting of a restaurant, theatre, sports facility, concert facility, and conference. It is to be understood that the preferential admission as described herein is more than and distinct from a conventional reservation or ticket purchase.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g. 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

Neither the Title (set forth at the beginning of the first page of the present application) nor the Abstract (set forth at the end of the present application) is to be taken as limiting in any way as the scope of the disclosed invention(s). An Abstract has been included in this application merely because an Abstract of not more than 150 words is required under 37 C.F.R. .sctn.1.72(b). The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

The preambles of the claims that follow recite purposes, benefits and possible uses of the claimed invention only and do not limit the claimed invention.

### II. Overview

The present invention is about a method and system of preferential admission requests by customers and acceptance by venues. More preferably, there in provided herein a preferential admission system that comprises a customer communication module for receiving requests for preferential admission to a venue, such request including a means to identify the venue and the size of the party for which the request is made; a venue communication module for delivering a notification of the request to the venue to which the preferential admission request applies, and for receiving the venue's acceptance of the request and confirmation that the preferential admission service was provided; and an accounting module for charging the customer a fee for the preferential admission transaction, and for crediting the venue for the preferential admission transaction.

The invention can be implemented in numerous ways, including as a process, an apparatus, a system, a computer readable medium such as a computer readable storage medium or a computer network wherein program instructions are sent over optical or communication links. In this specification, these implementations, or any other form that the invention may take, may be referred to as systems or techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

The following discussion provides a brief and general description of a suitable computing environment in which various embodiments of the system may be implemented. Although not required, embodiments will be described in the general context of computer-executable instructions, such as program applications, modules, objects or macros being executed by a computer. Those skilled in the relevant art will appreciate that the invention can be practiced with other computer configurations, including hand-held devices, multiprocessor systems, microprocessor-based or programmable consumer electronics, personal computers (“PCs”), network PCs, mini-computers, mainframe computers, and the like. The embodiments can be practiced in distributed computing environments where tasks or modules are performed by remote processing devices, which are linked through a communications network. In a distributed computing environment, program modules may be located in both local and remote memory storage devices.

A computer system may be used as a server including one or more processing units, system memories, and system buses that couple various system components including system memory to a processing unit. Computers will at times be referred to in the singular herein, but this is not intended to limit the application to a single computing system since in typical embodiments, there will be more than one computing system or other device involved. Other computer systems may be employed, such as conventional and personal computers, where the size or scale of the system allows. The processing unit may be any logic processing unit, such as one or more central processing units (“CPUs”), digital signal processors (“DSPs”), application-specific integrated circuits (“ASICs”), etc. Unless described otherwise, the construction and operation of the various components are of conventional design. As a result, such components need not be described in further detail herein, as they will be understood by those skilled in the relevant art.

A computer system includes a bus, and can employ any known bus structures or architectures, including a memory bus with memory controller, a peripheral bus, and a local bus. The computer system memory may include read-only memory (“ROM”) and random access memory (“RAM”). A basic input/output system (“BIOS”), which can form part of the ROM, contains basic routines that help transfer information between elements within the computing system, such as during startup.

The computer system also includes non-volatile memory. The non-volatile memory may take a variety of forms, for example a hard disk drive for reading from and writing to a hard disk, and an optical disk drive and a magnetic disk drive for reading from and writing to removable optical disks and magnetic disks, respectively. The optical disk can be a CD-ROM, while the magnetic disk can be a magnetic floppy disk or diskette. The hard disk drive, optical disk drive and magnetic disk drive communicate with the processing unit via the system bus. The hard disk drive, optical disk drive and magnetic disk drive may include appropriate interfaces or controllers coupled between such drives and the system bus, as is known by those skilled in the relevant art. The drives, and their associated computer-readable media, provide non-volatile storage of computer readable instructions, data structures, program modules and other data for the computing system. Although a computing system may employ hard disks, optical disks and/or magnetic disks, those skilled in the relevant art will appreciate that other types of non-volatile computer-readable media that can store data accessible by a computer system may be employed, such a magnetic cassettes, flash memory cards, digital video disks (“DVD”), Bernoulli cartridges, RAMs, ROMs, smart cards, etc.

Various program modules or application programs and/or data can be stored in the computer memory. For example, the system memory may store an operating system, end user application interfaces, server applications, and one or more application program interfaces (“APIs”).

The computer system memory also includes one or more networking applications, for example a Web server application and/or Web client or browser application for permitting the computer to exchange data with sources via the Internet, corporate Intranets, or other networks as described below, as well as with other server applications on server computers such as those further discussed below. The networking application in the preferred embodiment is markup language based, such as hypertext markup language (“HTML”), extensible markup language (“XML”) or wireless markup language (“WML”), and operates with markup languages that use syntactically delimited characters added to the data of a document to represent the structure of the document. A number of Web server applications and Web client or browser applications are commercially available, such those available from Mozilla and Microsoft.

The operating system and various applications/modules and/or data can be stored on the hard disk of the hard disk drive, the optical disk of the optical disk drive and/or the magnetic disk of the magnetic disk drive.

A computer system can operate in a networked environment using logical connections to one or more client computers and/or one or more database systems, such as one or more remote computers or networks. A computer may be logically connected to one or more client computers and/or database systems under any known method of permitting computers to communicate, for example through a network such as a local area network (“LAN”) and/or a wide area network (“WAN”) including, for example, the Internet. Such networking environments are well known including wired and wireless enterprise-wide computer networks, intranets, extranets, and the Internet. Other embodiments include other types of communication networks such as telecommunications networks, cellular networks, paging networks, and other mobile networks. The information sent or received via the communications channel may, or may not be encrypted. When used in a LAN networking environment, a computer is connected to the LAN through an adapter or network interface card (communicatively linked to the system bus). When used in a WAN networking environment, a computer may include an interface and modem or other device, such as a network interface card, for establishing communications over the WAN/Internet.

In a networked environment, program modules, application programs, or data, or portions thereof, can be stored in a computer for provision to the networked computers. In one embodiment, the computer is communicatively linked through a network with TCP/IP middle layer network protocols; however, other similar network protocol layers are used in other embodiments, such as user datagram protocol (“UDP”). Those skilled in the relevant art will readily recognize that these network connections are only some examples of establishing communications links between computers, and other links may be used, including wireless links.

While in most instances a computer will operate automatically, where an end user application interface is provided, a user can enter commands and information into the computer through a user application interface including input devices, such as a keyboard, and a pointing device, such as a mouse. Other input devices can include a microphone, joystick, scanner, etc. These and other input devices are connected to the processing unit through the user application interface, such as a serial port interface that couples to the system bus, although other interfaces, such as a parallel port, a game port, or a wireless interface, or a universal serial bus (“USB”) can be used. A monitor or other display device is coupled to the bus via a video interface, such as a video adapter (not shown). The computer can include other output devices, such as speakers, printers, etc.

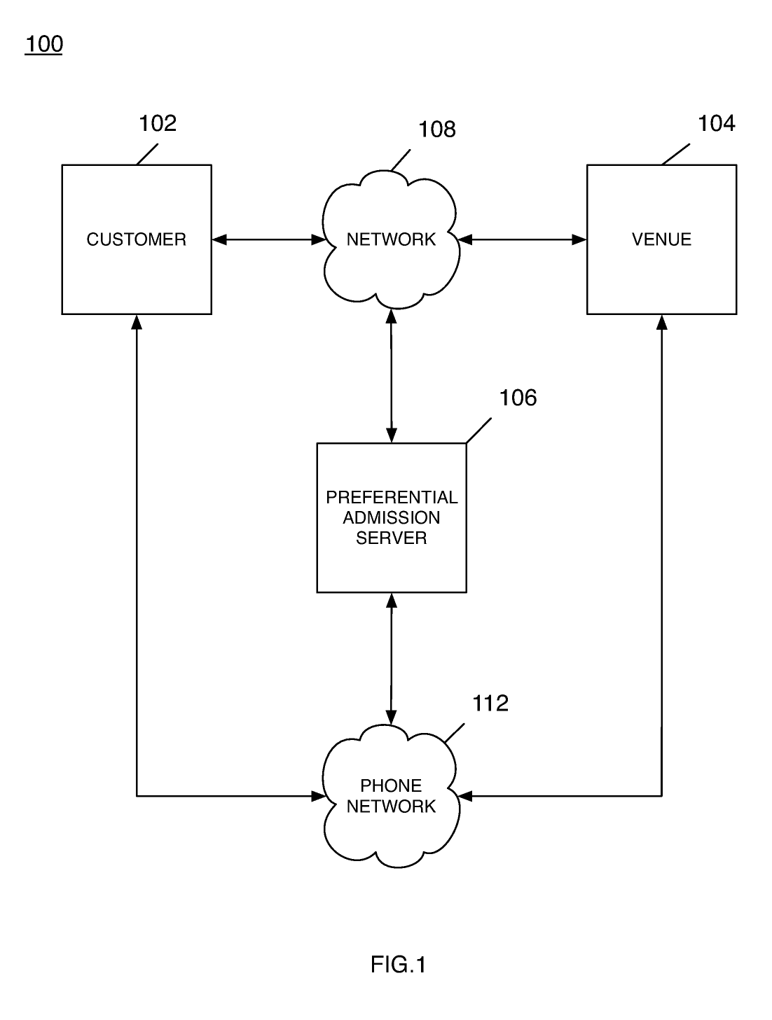

FIG. 1 is a high-level block diagram of a computing environment 100 according to one embodiment of the present invention. FIG. 1 illustrates a customer 102, a venue 104, and a preferential admission server 106 connected by a network 108, and by a phone network 112.

The customer 102 in this embodiment represents an entity that wishes to obtain preferred admission through requests via the network 108. As used herein, the customer 102 may represent either an individual or a group.

In one embodiment, the customer 102 includes a computer system that is utilized by an end-user to communicate with other computers on the network 108 in order to request and confirm a preferred admission transaction. The computer system, for example, can be a personal computer executing a web browser such as MICROSOFT INTERNET EXPLORER that allows the end-user to retrieve and display content from web servers and other computer systems on the network 108. In another embodiment, the customer 102 includes a mobile device, such as a mobile phone or touchpad, with a web browser. In another embodiment, the customer 102 includes a mobile device, such as a mobile phone or touchpad, with an installed mobile application providing user interface elements customized for the present invention. In another embodiment, the customer 102 includes a mobile phone or landline phone connected to phone network 112 and not connected to network 108, utilizing an interactive voice response user interface. In other embodiments, the customer 102 includes a network-capable device other than a computer system, such as a personal digital assistant (PDA), a cellular telephone, a pager, a television “set-top box” etc. Although FIG. 1 illustrates only a single customer 102, embodiments of the present invention can have thousands or millions of customers participating in the preferential admission marketplace system described herein. The single customer 102 is illustrated in order to simplify and clarify the present description. As used herein, the reference number 102 refers to both a single customer and/or a set of customers, depending upon the context.

Similarly, the venue 104 represents an entity for which preferential admission services may be requested in the preferential admission marketplace via the network 108.

In one embodiment, the venue 104 includes a computer system acting as a web browser that is utilized to receive, review, and accept or decline requests for preferred admission from the preferential admission server 106. In another embodiment, the venue 104 includes a landline or mobile phone number and multiplicity of venue phone terminals 114 that ring when said number is called. In another embodiment, the venue 104 includes a mobile device, such as a mobile phone or touchpad, with a web browser. In another embodiment, the venue 104 includes a mobile device, such as a mobile phone or touchpad, with an installed mobile application providing user interface elements customized for the present invention. In another embodiment, the venue 104 includes a mobile phone or landline phone connected to phone network 112 and not connected to network 108, utilizing an interactive voice response user interface. Although FIG. 1 illustrates only a single venue 104, embodiments of the present invention can have many venues participating in the preferred admission system. The single venue 104 is illustrated in order to simplify and clarify the present description. As used herein, the reference number 104 refers to both a single venue and/or a set of venues, depending upon the context.

The preferential admission server 106 represents an entity that coordinates a preferential admission transaction between the customer 102 and the venue 104. In one embodiment, the preferential admission server 106 operates a system for discovery of venues 104 by customers 102, and for the initiation and completion of preferential transactions between customers 102 and venues 104, including confirmation of the provision of the preferential admission service and charging of customer 102 for the transaction.

Although FIG. 1 illustrates only a single preferential admission server 106, embodiments of the present invention can have multiple servers participating in the electronic preferential admission system. In one embodiment, the preferential admission server 106 is said to be “remote” from the customer 102 and/or venue 104. “Remote” in this context means that the preferential admission server is logically separate from the customer and/or venue, and does not necessarily refer to a physical distance between the entities.

The network 108 represents the communication pathways between the customer 102, venue 104, and preferential admission server 106. In one embodiment, the network 108 is the Internet. The network 108 can also utilize dedicated or private communications links that are not necessarily part of the Internet. In one embodiment, the network 108 uses standard communications technologies and/or protocols. Thus, the network 108 can include links using technologies such as 802.11, integrated services digital network (ISDN), digital subscriber line (DSL), asynchronous transfer mode (ATM), etc. Similarly, the networking protocols used on the network 108 can include multiprotocol label switching (MPLS), the transmission control protocol/Internet protocol (TCP/IP), the hypertext transport protocol (HTTP), the simple mail transfer protocol (SMTP), the file transfer protocol (FTP), etc. The data exchanged over the network 108 can be represented using technologies and/or formats including the hypertext markup language (HTML), the extensible markup language (XML), etc. In addition, all or some of links can be encrypted using conventional encryption technologies such as the secure sockets layer (SSL), Secure HTTP and/or virtual private networks (VPNs). In another embodiment, the entities can use custom and/or dedicated data communications technologies instead of, or in addition to, the ones described above.

The phone network 112 represents the Public Switched Telephone Network (PSTN) interconnecting the customer 102, venue 104, and preferential admission server 106.

### III. System Architecture

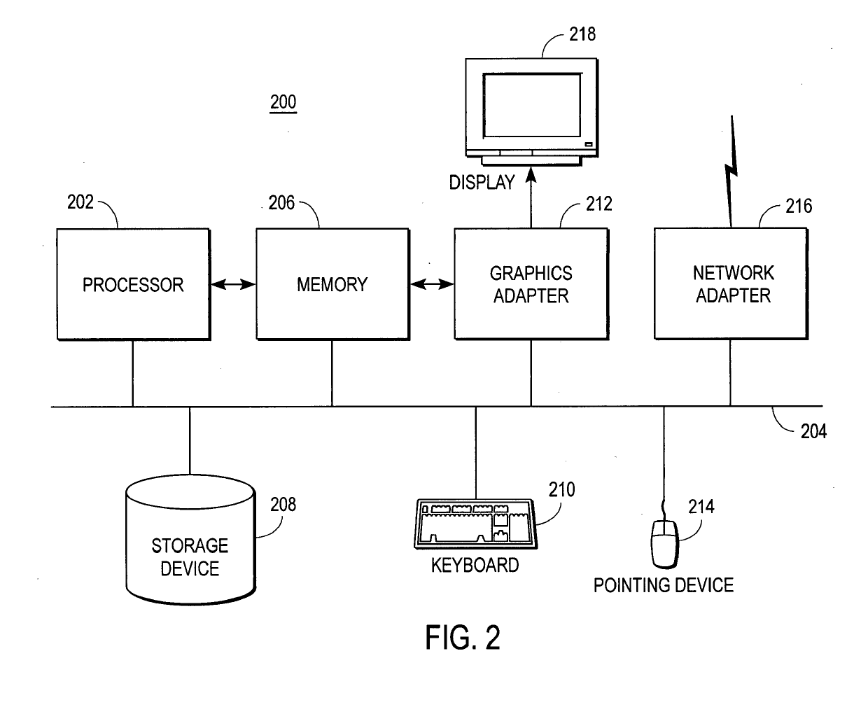

FIG. 2 is a high-level block diagram illustrating a functional view of a typical computer system 200 for use as one of the entities illustrated in the environment 100 of FIG. 1 according to an embodiment of the present invention. Illustrated are at least one processor 202 coupled to a bus 204. Also coupled to the bus 204 are a memory 206, a storage device 208, a keyboard 210, a graphics adapter 212, a pointing device 214, and a network adapter 216. A display 218 is coupled to the graphics adapter 212.

The processor 202 may be any general-purpose processor such as an INTEL x86, ARM, or POWERPC compatible-CPU. The storage device 208 is, in one embodiment, a hard disk drive but can also be any other device capable of storing data, such as a writeable compact disk (CD) or DVD, or a solid-state memory device. The memory 206 may be, for example, firmware, read-only memory (ROM), non-volatile random access memory (NVRAM), and/or RAM, and holds instructions and data used by the processor 202. The pointing device 214 may be a mouse, track ball, touch screen, or other type of pointing device, and is used in combination with the keyboard 210 to input data into the computer system 200. The graphics adapter 212 displays images and other information on the display 218. The network adapter 216 couples the computer system 200 to the network 108.

As is known in the art, the computer system 200 is adapted to execute computer program modules. As used herein, the term “module” refers to computer program logic and/or data for providing the specified functionality. A module can be implemented in hardware, firmware, and/or software. In one embodiment, the modules are stored on the storage device 208, loaded into the memory 206, and executed by the processor 202.

The types of computer systems 200 utilized by the entities of FIG. 1 can vary depending upon the embodiment and the processing power utilized by the entity. For example, the customer 102 and venue 104 typically require less processing power than the preferential admission server 106. Thus, the customer computer system and venue computer system can be standard personal computer systems. The preferential admission server computer system, in contrast, may comprise more powerful computers and/or multiple computers working together to provide the functionality described herein.

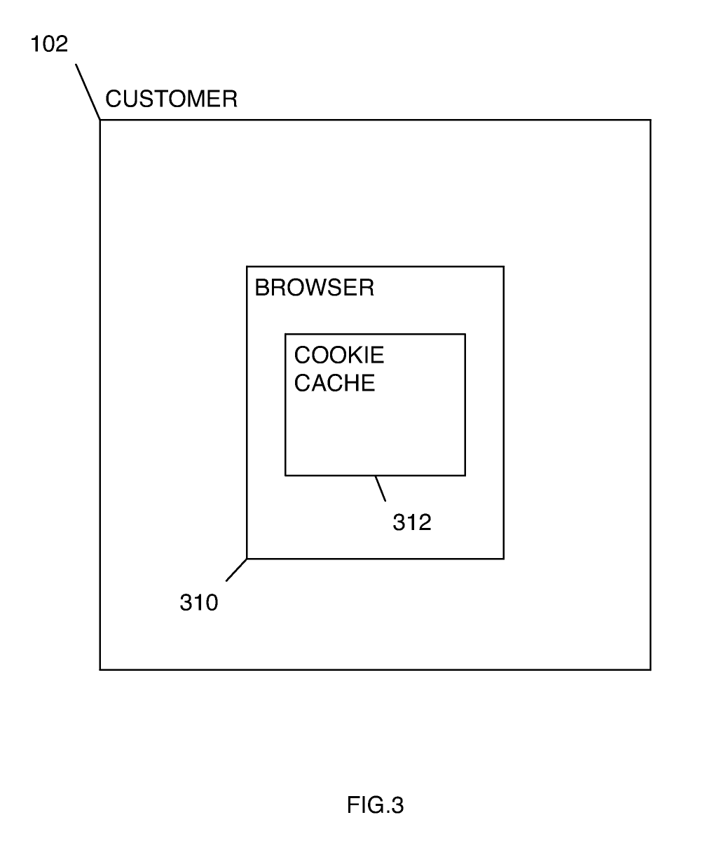

FIG. 3 is a high-level block diagram illustrating modules within a customer 102 according to one embodiment. Those of skill in the art will recognize that other embodiments can have different and/or other modules than the ones described here, and that the functionalities can be distributed among the modules in a different manner.

As shown in FIG. 3, the customer 102 includes a browser module 310 that allows the customer to view web pages provided by the venue 104, preferential admission server 106, and/or other entities on the network 108. In one embodiment, the browser module 310 is a conventional web browser, such as MICROSOFT INTERNET EXPLORER or MOZILLA FIREFOX. In one embodiment, the browser module 310 maintains a cookie cache 312 that stores cookies associated with web sites on the network 108. The preferential admission server 106 can communicate with the browser module 310 and instruct it to create a cookie in the cookie cache 312 holding certain information. The browser module 310 provides the cookie to the venue 104 and/or preferential admission server 106 when the browser connects to the site that created it.

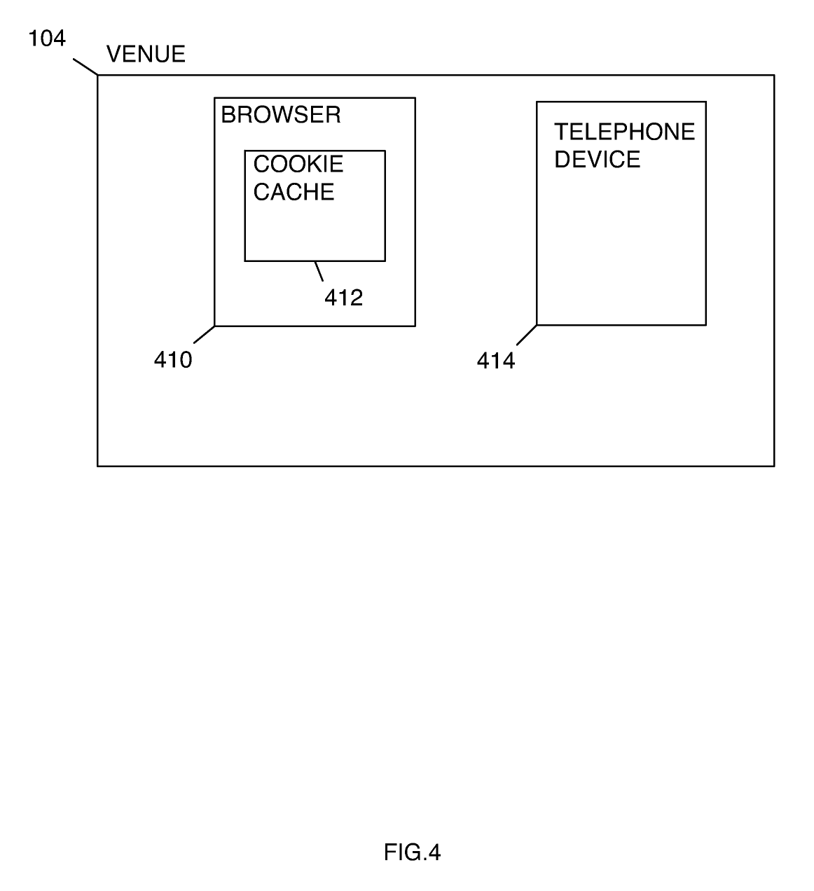

FIG. 4 is a high-level block diagram illustrating modules within a venue 104 according to one embodiment. Those of skill in the art will recognize that other embodiments can have different and/or other modules than the ones described here, and that the functionalities can be distributed among the modules in a different manner.

As shown in FIG. 4, in one embodiment the venue 104 includes a browser module 410 that allows the venue to view web pages provided by the preferential admission server 106, and/or other entities on the network 108. In one embodiment, the browser module 410 is a conventional web browser, such as MICROSOFT INTERNET EXPLORER or MOZILLA FIREFOX. In one embodiment, the browser module 410 maintains a cookie cache 412 that stores cookies associated with web sites on the network 108. The preferential admission server 106 can communicate with the browser module 410 and instruct it to create a cookie in the cookie cache 412 holding certain information. The browser module 410 provides the cookie to the preferential admission server 106 when the browser connects to the site that created it.

In another embodiment, the venue 104 includes a telephone device 414 connected to phone network 112. The telephone device 414 allows the venue 104 to receive phone calls from an interactive voice response function provided by the preferential admission server 106, and to provide response input via the DTMF key functionality of the telephone device 414.

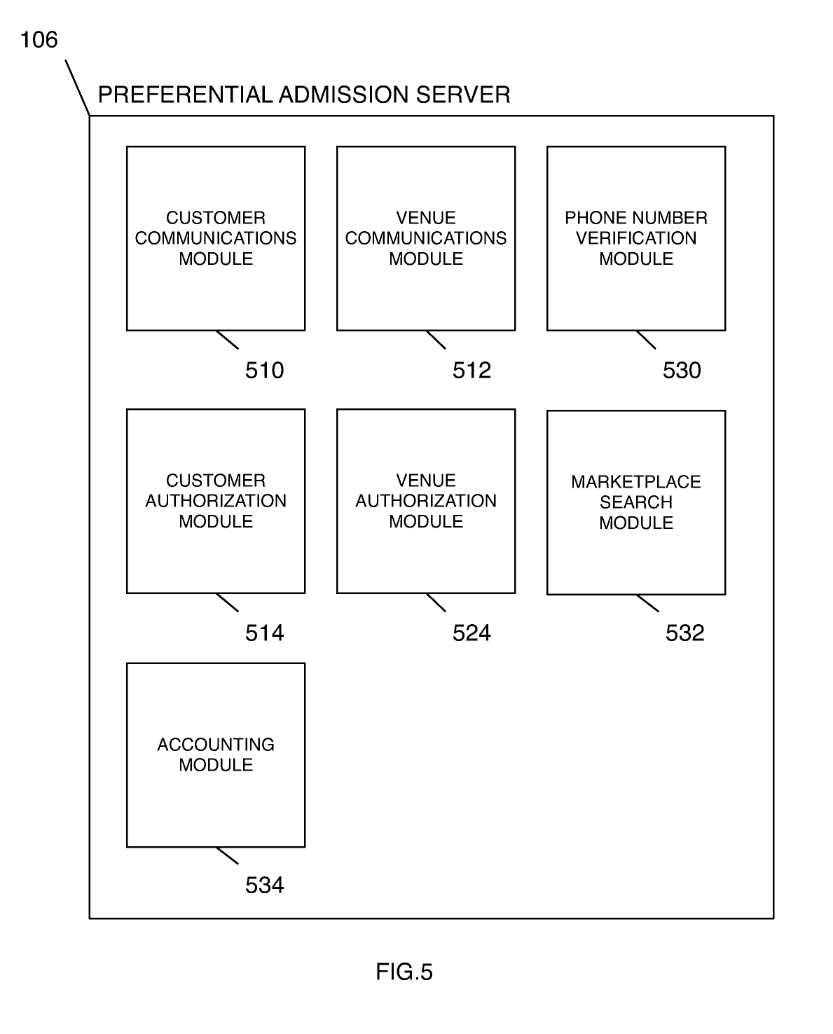

FIG. 5 is a high-level block diagram illustrating modules within the preferential admission server 106 according to one embodiment. Those of skill in the art will recognize that other embodiments can have different and/or other modules than the ones described here, and that the functionalities can be distributed among the modules in a different manner.

The preferential admission server 106 includes a customer communications module 510 that communicates with the customer 102 via the network 108. In one embodiment, the customer communications module 510 includes a web server that provides web pages to the customer 102 and receives end-user input sent over the network 108 by the customer's browser module 310. The customer communications module 510 thus allows a customer to navigate the preferential admission marketplace web site.

In one embodiment, the preferential admission server 106 includes a venue communications module 512 that communicates with the venue 104 via the network 108. In one embodiment, the venue communications module 512 includes a web server that provides web pages to the venue 104 and receives end-user input sent over the network 108 by the venue's browser module 410. The venue communications module 512 thus allows a venue to navigate the preferential admission request delivery web site. In another embodiment, the preferential admission server 106 includes a venue communications module 512 that communicates with the venue 104 via the phone network 112, using interactive voice response functionality.

A customer authorization module 514 authenticates and authorizes customers 102 seeking to use the preferential admission server 106 for preferential admission requests. In one embodiment, the customer authorization module 514 maintains an ID, password, and/or other information for each customer 102. The customer 102 supplies the correct information in order to identify and authenticate itself. In general, when a customer 102 contacts the preferential admission server 106 to make a request, the customer's relationship with the preferential admission server 106 fits into one of three categories: new customer, existing customer that has not been active recently, or existing active customer. In one embodiment, the customer authorization module 514 determines the category of the customer 102 and responds accordingly.

If the customer 102 is new, an embodiment of the customer authorization module 514 presents the customer 102 with one or more web pages that allow the customer to create an account and select an ID, password and/or other identifying information. In one embodiment, the customer 102 also supplies payment information specifying a charge account and/or creating a stored value account. The payment information can include, for example, a credit card number or a gift certificate identifier.

If the customer 102 already has an account but has not been active recently (e.g., within the previous 10 minutes), in one embodiment the customer authorization module 514 provides the customer with the standard login prompt and thereby allows the customer to log into the preferential admission server 106. If the customer 102 has been active recently, one embodiment of the customer authorization module 514 allows the customer to directly access the preferential admission server 106 without additional authentication procedures. After each successful login, one embodiment of the customer authorization module 514 places a cookie in the customer's browser module 310 that identifies the customer and indicates the time of the customer's last login. In another embodiment, the cookie identifies the expiration date/time after which the customer's activity is no longer considered “recent.” The cookie thus allows the customer authorization module 514 to determine the customer's status with respect to the preferential admission server 106 and respond appropriately.

A venue authorization module 524 authenticates and authorizes venues 104 seeking to use the preferential admission server 106 for receiving, viewing and responding to preferential admission requests. In one embodiment, the venue authorization module 524 maintains an ID, password, and/or other information for each venue 104. The venue 104 supplies the correct information in order to identify and authenticate itself. In general, when a venue 104 contacts the preferential admission server 106 to make a request, the venue's relationship with the preferential admission server 106 fits into one of three categories: new venue, existing venue that has not been active recently, or existing active venue. In one embodiment, the venue authorization module 524 determines the category of the venue 104 and responds accordingly.

If the venue 104 is new, an embodiment of the venue authorization module 524 presents the venue 104 with one or more web pages that allow the venue to create an account and select an ID, password and/or other identifying information.

If the venue 104 already has an account but has not been active recently (e.g., within the previous 10 minutes), in one embodiment the venue authorization module 524 provides the venue 104 with the standard login prompt and thereby allows the venue 104 to log into the preferential admission server 106. If the venue 104 has been active recently, one embodiment of the venue authorization module 524 allows the venue to directly access the preferential admission server 106 without additional authentication procedures. After each successful login, one embodiment of the venue authorization module 524 places a cookie in the venue's browser module 410 that identifies the venue 104 and indicates the time of the venue's last login. In another embodiment, the cookie identifies the expiration date/time after which the venue's activity is no longer considered “recent.” The cookie thus allows the venue authorization module 524 to determine the venue's status with respect to the preferential admission server 106 and respond appropriately.

In one embodiment, a phone number verification module 530 verifies phone numbers that customers 102 and venues 104 supply as a detail of the customer or venue account information, respectively. In one embodiment, a customer 102 or venue 104 supplies a phone number via a form in a web page served by the preferential admission server 106. In one embodiment, the phone number verification module 530 supplies the customer or venue with a verification code consisting of a short sequence of digits. The phone number verification module 530 makes a phone call via the phone network 112 to the phone number supplied by the customer 102 or venue 104. The customer 102 or venue 104 answers the phone call. In one embodiment the phone number verification module 530 plays a recorded message instructing the called party to enter the verification code supplied earlier via their phone's DTMF keypad functionality. The customer 102 or venue 104 enters the verification code via their phone's DTMF keypad functionality.

In another embodiment, a phone number verification module 530 verifies phone numbers that customers 102 and venues 104 supply as a detail of the customer or venue account information, respectively, via Short Message Service (SMS) text messaging. A customer or venue supplies a phone number to the preferential admission server 106. In one embodiment, the phone number verification module 530 sends an SMS text message containing a verification code consisting of a short sequence of alphanumeric symbols. In one embodiment, the customer 102 or venue 104 supplies the verification code via a form in a web page served by the preferential admission server 106.

In one embodiment, a marketplace search module 532 provides customers 102 with access to a marketplace search of venues 104 for which preferential admission may be requested. These capabilities allow a customer 102 to provide the marketplace search module 526 with a search query that specifies search parameters such as a location, keywords, meta-data describing desired results, and/or other information and receive in return a list of venues 104 containing information about each venue 104 that at least partially satisfies the query. In one embodiment, the marketplace search module 532 requests from the customer 102 the customer's current location via the customer browser 310 using the W3C Geolocation API. In one embodiment, the returned list of venues includes the price a customer 102 will be charged for request 612 for preferential admission. In one embodiment, the returned list of venues includes the price a customer 102 will be charged for an accepted 618 request. In one embodiment, the returned list of venues includes the price a customer 102 will be charged for a confirmed 624 transaction. In some embodiments, the marketplace search module 532 may provide different prices for offered preferential admission transactions depending on the venue 102, party size, time, date, seating or admission section, current demand in terms of lineup length or reservation load, or anticipated demand in terms of lineup length or reservation load.

An accounting module 534 monitors the transactions that occur using the preferential admission server 106, invoices the customers 102, and credits the venues 104. In a typical case, the accounting module 534 charges the customer's credit card or other method of payment and credits the venue's account for the amount of the transaction. In another embodiment, the accounting module 534 aggregates completed preferential admission transactions and then periodically credits each venue 104 for the value of the transactions completed within the time period. In yet another embodiment, the accounting module 520 aggregates a customer's completed preferential admission transactions within a given time period and then charges the customer's account once for the aggregate total of the completed transactions participated in by that customer 102.

### IV. Process/Example

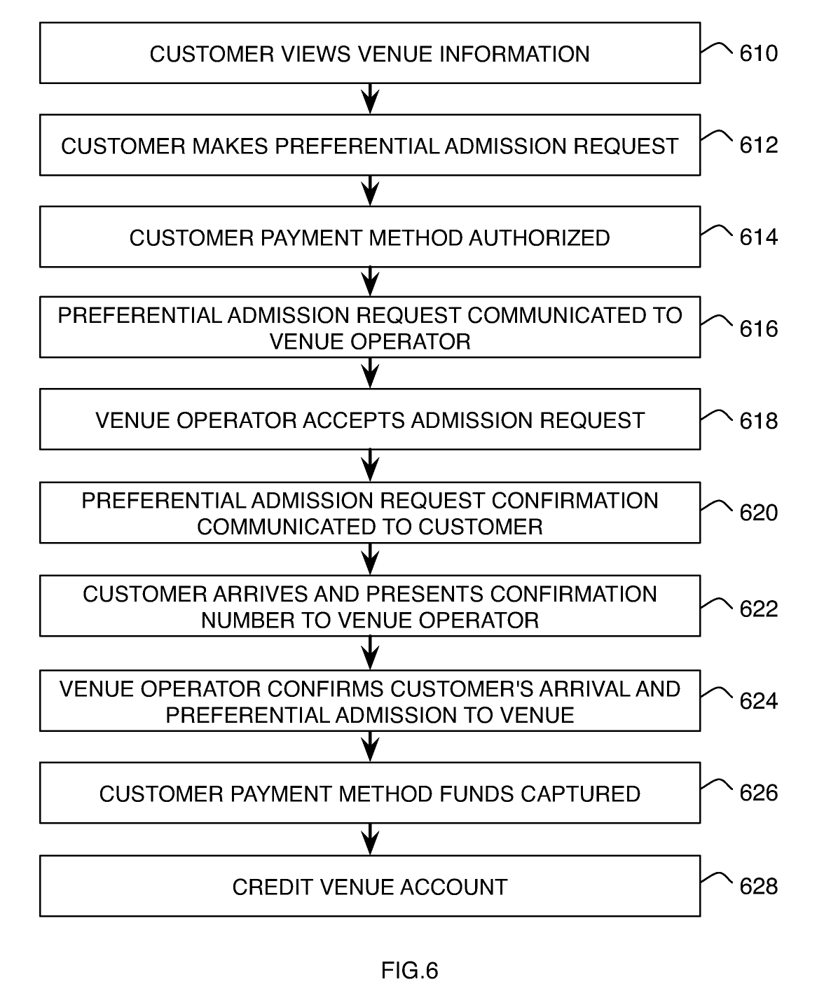

FIG. 6 is a flow chart illustrating the operation of the preferential admission server 106 according to one embodiment. Those of skill in the art will recognize that other embodiments can perform the steps of FIG. 6 in different orders. Moreover, other embodiments can include different and/or additional steps than the ones described here.

FIG. 6 illustrates steps performed by the preferential admission server 106 in an exemplary transaction where a customer 102 is requesting preferential admission service from a venue 104. Assume for purposes of this example that the customer 102 uses a web browser to browse the preferential admission marketplace web site, views 610 the venue information including the price for a preferred admission transaction for their given party size, and requests 612 preferential admission, including the size of the party for which the request is made.

The preferential admission server 106 authorizes 614 the availability of funds in the customer's credit card, debit card, stored value account, or other payment instrument.

The preferential admission server 106 communicates 616 the request to the venue 104. The request as communicated to the venue 104 includes the party size and the fee that will be paid by the customer 102 for receiving the preferential admission service. Assume for purposes of this example that the venue 104 uses a web browser to receive, view, and accept incoming preferential admission requests. The venue 104 responds by communicating 618 acceptance of the request to the preferential admission server 106.

The preferential admission server 106 communicates 620 acceptance of the preferential admission request to the customer 102.

Customer 102 presents 622 their preferential admission confirmation number to venue 104 for performance of the preferential admission service. Upon performance of the preferential admission service for the customer 102 and the other members the party for which customer 102 made the request, venue 104 confirms 624 via communication to the preferential admission server 106 that customer 102 and the other members of the party have been provided preferential admission by venue 104.

The preferential admission server 106 captures 626 funds from the payment instrument of customer 102 equal to the amount owed for the service plus all applicable taxes.

The preferred admission server 106 credits 628 the venue 104 for the transaction. In one embodiment, the preferential admission service 106 keeps a percentage of the transaction and/or charges the venue 104 a fee for conducting the transaction.

### V. Computing

Further and in addition to the disclosure provided above, it will be readily apparent to one of ordinary skill in the art that the various processes and methods described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., a computer program.

A “processor” means one or more microprocessors, central processing units (CPUs), computing devices, microcontrollers, digital signal processors, or like devices or any combination thereof.

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

As will be apparent to those skilled in the art, the various embodiments described above can be combined to provide further embodiments. Aspects of the present systems, methods and components can be modified, if necessary, to employ systems, methods, components and concepts to provide yet further embodiments of the invention. For example, the various methods described above may omit some acts, include other acts, and/or execute acts in a different order than set out in the illustrated embodiments.

The present methods, systems and articles also may be implemented as a computer program product that comprises a computer program mechanism embedded in a computer readable storage medium. For instance, the computer program product could contain program modules. These program modules may be stored on CD-ROM, DVD, magnetic disk storage product, flash media or any other computer readable data or program storage product. The software modules in the computer program product may also be distributed electronically, via the Internet or otherwise, by transmission of a data signal (in which the software modules are embedded) such as embodied in a carrier wave.

For instance, the foregoing detailed description has set forth various embodiments of the devices and/or processes via the use of examples. Insofar as such examples contain one or more functions and/or operations, it will be understood by those skilled in the art that each function and/or operation within such examples can be implemented, individually and/or collectively, by a wide range of hardware, software, firmware, or virtually any combination thereof. In one embodiment, the present subject matter may be implemented via ASICs. However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, flash drives and computer memory; and transmission type media such as digital and analog communication links using TDM or IP based communication links (e.g., packet links).

Further, in the methods taught herein, the various acts may be performed in a different order than that illustrated and described. Additionally, the methods can omit some acts, and/or employ additional acts.

These and other changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

We claim:

1. A server in an electronic preferential admission system, the server comprising: a non-transitory computer-readable storage medium having executable computer program instructions for facilitating electronic preferential admission transactions between remote customers and remote venues, the computer program instructions comprising:
a customer communication module configured to receive a request for preferential admission at the server from a remote customer device, the request identifying the venue for which the preferential admission is requested, the request also identifying the party size for which the preferential admission is requested;
a venue communication module configured to deliver a request for preferential admission from the server to a remote venue device, the venue communication module further configured to receive a response from the remote venue device accepting or declining the request;
and a processor for executing the computer program instructions.

2. The server of claim 1, wherein the venue communications module is configured to encode the request for preferential admission as a hypertext transport protocol (HTTP) message.

3. The server of claim 1, wherein the venue communications module is configured to deliver the request for preferential admission as an audio signal played in a phone call.

4. The server of claim 1 wherein the venue communications module comprises a means to request and receive from customer communication module payment for preferential admission.

5. A computer product having a non-transitory computer-readable storage medium having executable computer program instructions embodied therein for providing a server a means to facilitate preferred admission transactions between remote customers and remote venues, the computer product comprising:
a customer communication module configured to receive a request for preferential admission at the server from a remote customer device, the request identifying the venue for which the preferential admission is requested, the request also identifying the party size for which the preferential admission is requested; and
a venue communication module configured to deliver a request for preferential admission from the server to a remote venue device, the venue communication module further configured to receive a response from the remote venue device accepting or declining the request.

6. A method for facilitating preferred admission transactions between venues and customers, comprising:
receiving a request for preferential admission at a server from a customer device, the request identifying the venue to which the request applies;
delivering a notification of request for preferential admission to a remote venue device;
receiving a response at the server from the remote venue device, the response indicating either acceptance or rejection of the request for preferential admission;
delivering notification of acceptance of the preferential admission request to the customer device;
and charging the customer for the preferred admission service.

7. The method of claim 6, further comprising the step of receiving a confirmation at the server from the remote venue device, the confirmation indicating that the customer has been provided the preferential admission service.

8. The method of claim 6, wherein the step of receiving a confirmation is required within a limited period of time following the step of receiving a response from the remote venue device indicating acceptance of the preferential admission request, and wherein the step of charging the customer is only performed if the confirmation is received within the limited period of time.

9. The method of claim 6, wherein the notification of request for preferential admission delivered to the remote venue device includes a confirmation number, and wherein the notification of acceptance of the preferential admission request delivered to the remote customer device includes the same confirmation number.

10. The method of claim 6, wherein the notification of request for preferential admission delivered to the remote venue device includes the name of the customer.

11. A non-transitory computer-readable storage medium having executable computer program instructions for providing a server in a system having remote customers and remote venues, the server for facilitating preferred admission transactions between the remote customers and the remote venues, the computer program instructions comprising:
a customer communication module configured to receive a request for preferential admission at the server from a remote customer device, the request identifying the venue for which the preferential admission is requested, the request also identifying the party size for which the preferential admission is requested;
and a venue communication module configured to deliver a request for preferential admission from the server to a remote venue device, the venue communication module further configured to receive a response from the remote venue device accepting or declining the request.

12. A method for a customer to reserve at least one place and concurrently secure preferential admission at a venue which comprises:
a) sending from a customer device a request for both a reservation and a preferential admission to a venue, the request identifying the venue to which the request applies and the number of desired reservations and preferential admissions;
b) delivering a notification of request for both the reservation and preferential admission to a venue device;
c) receiving a response from the venue device, the response indicating either acceptance or rejection of the request for the reservation and indicating either acceptance or rejection of the request for the preferential admission (the “outcomes”);
d) delivering notification of the outcomes to the customer device; and
e) if there is acceptance of the the request for the preferential admission charging the customer for such preferential admission.

13. The method of claim 6 wherein the venue is selected from the group consisting of a restaurant, theatre, sports facility, concert facility, and conference.

14. The method of claim 12 wherein the venue is selected from the group consisting of a restaurant, theatre, sports facility, concert facility, and conference.

15. A storage medium containing machine instructions readable by a computer system that includes a data store to configure the computer system to perform the method of claim 6.

16. A storage medium containing machine instructions readable by a computer system that includes a data store to configure the computer system to perform the method of claim 12.

17. An apparatus comprising: a storage device; a processor connected to the storage device; the storage device storing a program for controlling the processor; and the processor operative with the program to: receive a request for preferential admission to a venue, in which the request to secure admission to said venue ahead of other customers who have not paid extra for such admission for a particular time and a particular date; determine an availability of the request for such preferential admission; outputting an indicia that the request for such preferential admission has been accepted or denied.
